(19) United States
(12) Patent Application Publication
(10) Pub. No.: US 2025/0045351 A1
(43) Pub. Date: Feb. 6, 2025

(54) OPTIMIZED CIRCUIT TO CORRECT FUNCTION APPROXIMATION OUTLIERS

(71) Applicant: INTERNATIONAL BUSINESS MACHINES CORPORATION, ARMONK, NY (US)

(72) Inventors: ROBERT FREDERICK ENENKEL, MARKHAM (CA); CHRISTOPHER ANAND, DUNDAS (CA); SILVIA MELITTA MUELLER, ST. INGBERT (DE); LUCAS DUTTON, HAMILTON (CA); YU-SHIUAN WU, NEWMARKET (CA)

(21) Appl. No.: 18/362,359

(22) Filed: Jul. 31, 2023

(51) Int. Cl. G06F 17/17

(52) U.S. Cl. CPC G06F 17/17

(57) ABSTRACT

Correction of outliers in a data set includes receiving a first set of inputs of an input dataset requiring positive correction; and receiving a second set of inputs of the input dataset requiring negative correction. Conjunctive clauses with a predetermined number of terms that make all members in the second set of inputs false are identified to form a set of identified conjunctive clauses. Members from the first set of inputs that evaluate to true are collected for each conjunctive clause in the set of identified clauses. The set of identified conjunctive clauses are iterated through until all of the first set of inputs evaluates to true, and the conjunctive clauses are disjuncted to form a disjuncted expression. A correction circuit for the input dataset is generated based on the disjuncted expression.

### BACKGROUND

### Field of the Disclosure

The field of the disclosure is data processing, or, more specifically, methods, apparatus, and products for an optimized circuit to correct function approximation outliers.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

The performance of data processing applications such as artificial intelligence (AI), analytics, and databases often depends upon a small number of important mathematical functions used for computation. For AI applications, linear operations are important and are often performed using specialized hardware accelerators. As a result, non-linear functions are often dominant in terms of execution time of algorithms including basic arithmetic functions (e.g., divide) and specialized functions (e.g., activation functions such as sigmoid). One common problem for standard functions is that AI applications are very sensitive to performance but tolerate lower precision. Other applications using the same functions may be very sensitive to accuracy. In many computing systems, arithmetic engines share components necessitating that both requirements be met with the same hardware.

Many functions require additional steps to achieve the highest level of accuracy for a result, which is to be correctly rounded, even though a less computationally expensive algorithm of circuit may produce correct results in all but a handful of cases. For example, a function which requires 20 cycles to compute may effectively be using 15 cycles to compute 22-bit accurate results, and 5 cycles to refine the last bit. Accordingly, a need exists to obtain the same results or better using less computationally expensive ways to achieve the results.

### SUMMARY

Methods, apparatus and systems for correction of outliers in a data set according to an embodiment include receiving a first set of inputs of an input dataset requiring positive correction, and receiving a second set of inputs of the input dataset requiring negative correction. Conjunctive clauses with a predetermined number of terms that make all members in the second set of inputs false are identified to form a set of identified conjunctive clauses. Members from the first set of inputs that evaluate to true are collected for each conjunctive clause in the set of identified clauses. The set of identified conjunctive clauses are iterated through until all of the first set of inputs evaluates to true, and the conjunctive clauses are disjuncted to form a disjuncted expression. A correction circuit for the input dataset is generated based on the disjuncted expression.

In another embodiment, a method for correction of outliers for a function includes receiving a set of potential adjustments to one or more output values of a function. Each of the one or more output values has a corresponding input value, and each input value and corresponding output value comprises an input/output pair. The method further includes receiving, for each of a plurality of inputs to the function, a set of acceptable output values for the function. The method further includes identifying, as outlier values, the input/output pairs for which a given output is not in the set of acceptable values for the given input. The method further includes determining, for the potential adjustments in the set of adjustments, a logical predicate which is true for a subset of the plurality of input values such that: a. at most one logical predicate is true for each input value, b. at least one logical predicate must be true for each input value associated with an outlier value, and c. when the corresponding potential adjustment is applied to the output value of the function evaluated at an input value for which the predicate produces a true value, the resulting adjusted output value is in the set of acceptable values.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 is a block diagram of automated computing machinery comprising an exemplary computing system configured for correcting function approximation outliers according to embodiments of the present disclosure.

FIG. 2 shows an example plot of subinterval unit in last place (ulp) error values and outliers to be corrected according to embodiments of the present disclosure.

FIG. 3 shows an example plot of identifying CNF circuits according to embodiments of the present disclosure.

FIG. 4 shows a table of clauses generated from the greedy method according to embodiments of the present disclosure.

FIG. 5 shows an example correction circuit description 500 in table form for a single precision reciprocal according to embodiments of the present disclosure.

FIG. 6 shows generating Boolean bits to be fed into a SAT minimizer according to embodiments of the present disclosure.

FIG. 7 is a flowchart of an example method for correcting function approximation outliers according to some embodiments of the present disclosure.

FIG. 8 is a flowchart of an example method for correction of outliers for a function according to some embodiments of the present disclosure.

### DETAILED DESCRIPTION

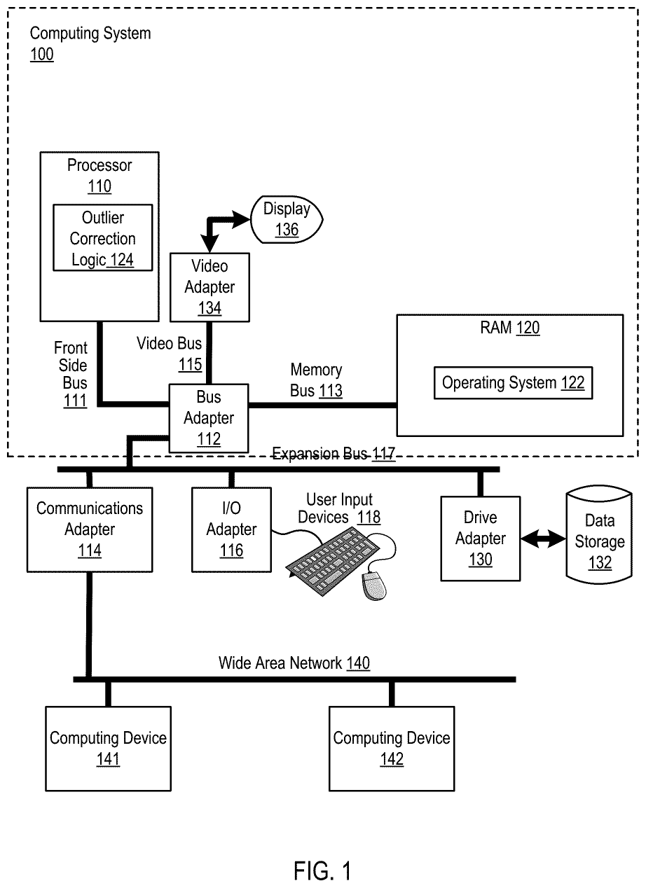

Exemplary apparatus and systems an optimized circuit to correct function approximation outliers in accordance with the present disclosure are described with reference to the accompanying drawings, beginning with FIG. 1. FIG. 1 sets forth a block diagram of automated computing machinery comprising an exemplary computing system 100 configured for correcting function approximation outliers according to embodiments of the present disclosure. The computing system 100 of FIG. 1 includes at least one computer processor 110 or ‘CPU’ as well as random access memory (‘RAM’) 120 which is connected through a high speed memory bus 113 and bus adapter 112 to processor 110 and to other components of the computing system 100. The processor 110 includes outlier correction logic 124 configured to perform correcting of function approximation outliers according to various embodiments described herein. In one or more embodiments, outlier correction logic 124 is implemented in hardware utilizing hardware logic such as logic gates. In particular embodiments, the outlier correction logic 124 may be utilized by applications such as AI, analytic, or database applications. For example, outlier corrections may be applied to estimate functions used by AI or when feeding into a rounding function to produce correctly rounded results. Although the outlier correction logic 124 is shown in the embodiment of FIG. 1 as being located within the processor 110, in other embodiments the outlier correction logic 124 is located within RAM 120 or a floating-point computation unit.

Stored in RAM 120 is an operating system 122. Operating systems useful in computers configured for function approximation according to embodiments of the present disclosure include UNIX™, Linux™, Microsoft Windows™, AIX™, and others as will occur to those of skill in the art. The operating system 122 in the example of FIG. 1 is shown in RAM 120, but many components of such software typically are stored in non-volatile memory also, such as, for example, on data storage 132, such as a disk drive.

The computing system 100 of FIG. 1 includes disk drive adapter 130 coupled through expansion bus 117 and bus adapter 112 to processor 110 and other components of the computing system 100. Disk drive adapter 130 connects non-volatile data storage to the computing system 100 in the form of data storage 132. Disk drive adapters according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system 100 of FIG. 1 includes one or more input/output (‘I/O’) adapters 116. I/O adapters implement user-oriented input/output through, for example, software drivers and computer hardware for controlling output to display devices such as computer display screens, as well as user input from user input devices 118 such as keyboards and mice. The example computing system 100 of FIG. 1 includes a video adapter 134, which is an example of an I/O adapter specially designed for graphic output to a display device 136 such as a display screen or computer monitor. Video adapter 134 is connected to processor 110 through a high speed video bus 115, bus adapter 112, and the front side bus 111, which is also a high speed bus.

The exemplary computing system 100 of FIG. 1 includes a communications adapter 114 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for inserting sequence numbers into editable tables according to embodiments of the present disclosure include modems for wired dial-up communications, Ethernet (IEEE 802.3) adapters for wired data communications, and 802.11 adapters for wireless data communications. The communications adapter 114 of FIG. 1 is communicatively coupled to a wide area network 140 that also includes other computing devices, such as computing devices 141 and 142 as shown in FIG. 1.

An existing approach to improving function approximation is to improve the underlying algorithm. Another existing approach to improving function approximation is to prove that the existing algorithm meets the required accuracy, including being correctly rounded. For some iterative algorithms, it is possible to perform an extra iteration to obtain a correctly rounded result. A general approach to rounding is to calculate a residual and round up and/or down based on this value. However, a problem with these existing approaches is that they are computationally expensive. In particular, an extra iteration or the calculation of a residual requires one or more additional floating-point operations.

Algorithms for evaluating algebraic functions can be separated into three distinct steps: computing an initial approximation from an input, refining the approximation to a desired accuracy, then rounding the output to the target precision. In some applications, the refinement and rounding steps are key aspects of the algorithm in order to guarantee sufficiently accurate results. When it comes to AI applications however, accuracy is less of a concern as long as the approximation meets a certain tolerance.

Various embodiments described herein are directed to analysis and solutions to meeting such tolerances, particularly by shrinking the worst-case bounds in terms of unit in last place (ulp) errors of an approximation by identifying error outliers in an approximation and generating an optimized circuit implementation based on a conjunctive/disjunctive normal form analysis as further described herein.

A floating-point number is typically represented by a sign bit indicating the sign (i.e., positive or negative), unsigned exponent bits, and mantissa/significand bits. A unit in last place (ulp) can be thought of as the place value of the lowest order bit of the significand. All of the numbers with the same ulp value are referred to as a binade. In practice, hardware implementations calculate exponent and significand values independently, and calculate the significand values using fixed-point arithmetic. Thus, the ulp value is the place value of a particular bit. It is convenient to define errors in terms of ulps of the correctly rounded result. For example, if we allow for 2 ulps of error, the set of possible ulp errors which can remain in the output is {−2, −1, 0, 1, 2}.

Approximation schemes usually produce outliers that exceed the desired accuracy or are outside a required tolerance. In accordance with various embodiments, for an algorithm that meets requirements except for a few inputs or regions of inputs, a correction circuit is calculated to correct one or more of the inputs or region of inputs. In the case of a few values which are not correctly rounded, the circuit calculates a 1-bit adjustment before a final rounding step. This adjustment may be applied for many inputs as long as it causes the incorrectly rounded values to round correctly, and does not change the rounding for inputs which were already correctly rounded. In an example embodiment for the case of an allowed error bound, e.g., |error|<4 ulp, the method calculates a final adjustment to be applied which may change many values, but would increase any values below the lower bound, decrease any values above the upper bound, and not cause any values within the bounds to go outside the bounds. This is often possible because approximation methods based on polynomial or other approximations do not produce randomly distributed errors, and errors below the lower bound are likely to be surrounded by values near the lower bound, which can also be adjusted in the positive direction.

In one or more embodiments, a circuit is constructed based on conjunctive normal forms (CNFs), disjunctive normal forms (DNFs) or other heuristics that use a small number of bits and logic gates to represent a superset of cases that require special correction. A Boolean expression is in Conjunctive Normal Form (CNF) if and only if it is either false or true, or a non-empty conjunction of disjunctive clauses c₁∧ . . . ∧cₙ, where a disjunctive clause is a non-empty disjunction of literals l₁ ∨ . . . ∧ lₙ. A literal is either a propositional variable pᵢ or the negation −pᵢ of a propositional variable. No propositional variable can occur more than once in the same disjunctive clause. Examples of CNFs are (p ∨ q) ∧ ¬p and p ∧ ¬q ∧ ¬r. CNFs are a way of representing Boolean expressions in a canonical form, i.e., any Boolean expression can be simplified into a CNF. It is used in computational problems such as the k-SAT problem, which involves finding a satisfying assignment to a Boolean formula expressed in CNF where each disjunctive clause contains at most k variables. Disjunctive Normal Forms (DNFs) can be defined in a similar fashion.

A common approach for generating function approximations are by using lookup tables. In its most general sense, a function can be tabulated as inputs being mapped to outputs. However, the input space is usually too large to tabulate every input and the corresponding output. A solution to this problem is to tabulate a subset of the input space, and use the value fetched from the table as the initial approximation to further refine the result. A commonly used refinement algorithm is Newton-Raphson iteration. However, use of the Newton-Raphson iteration may not be efficient to correct a small number of values or to slightly improve accuracy in an approximation.

To facilitate the refinement phase, careful consideration should be given to creating the lookup table. For transcendental functions, The Table Maker's Dilemma refers to the problem of finding an intermediate precision to obtain correctly rounded results. Various table design methods have been implemented to provide accurate tables. As a result, table values are never fully random, and follow patterns that are exploited in accordance with various embodiments as further described herein.

Lookup tables designed to be stored in hardware usually follow strict conditions, such as table size and table width. Furthermore, range reduction is performed on the inputs so that it is only necessary to store table values for a chosen interval. The chosen interval can be further divided into subintervals, where each subinterval's endpoints are denoted by adjacent values in the table. The cardinality of a subinterval depends not only on the lookup table, but also the precision n of the output. To compute values belonging in the subinterval, the underlying algorithm to compute the function of interest are performed for inputs that belong in the interval [x, x+1) where x is a table value, up until before a rounding step. This cardinality can be computed with the formula: cardinality=2^{n-w}. If the subinterval size is sufficiently small, the outputs can be exhaustively enumerated and their ulp errors recorded.

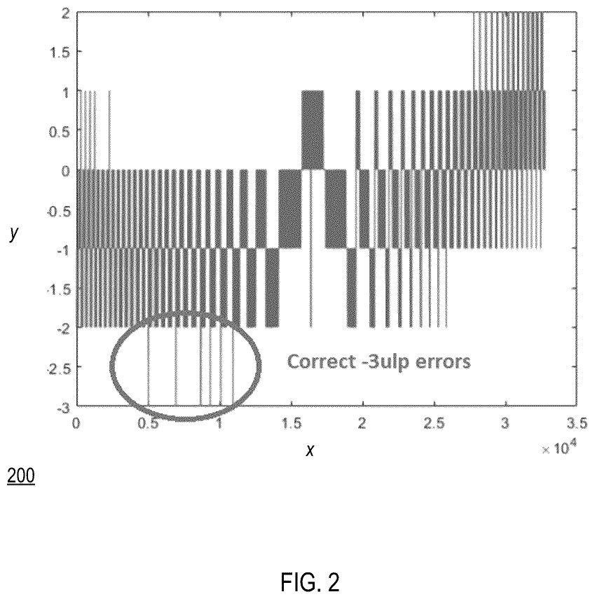

FIG. 2 shows an example plot 200 of subinterval ulp error values and outliers to be corrected according to embodiments of the present disclosure. The plot 200 of FIG. 2 is an error plot for an approximation to 1/x on a small interval. The x-axis shows individual input values in an interval that includes 32768 values in total. The y-axis shows the ulp error e of each value in the interval [−3, 2]. It can be observed that the ulp error values do not follow a smooth line or curve; rather, ulp error values oscillate in a predictable pattern. The example of FIG. 1 shows for the function 1/x in the input interval [1, 2), for a selected subinterval. Here an ulp error is in the range [−3, 2], but the −3 ulp errors are minimal and only belong to a specific portion of the subinterval. The errors are integer multiples of an ulp because the error is calculated on rounded values. The plot 200 appears as a collection of rectangles because the error jumps up and down by one at a high frequency. However, the pattern of rectangles is not random. It can be seen that one region in a range from x=500 to x=1200 contains a few −3 ulp errors, but no positive errors. As a result, the whole region can be adjusted by +1 ulp. Embodiments described herein are able to effectively correct these outliers in the example, with the overall goal of removing the outlier and providing an ulp error in the range [−2, 2].

In one or more embodiments, an input value for evaluation by a function is received. An approximate output value of the function is calculated from the input value using an approximation function based on an existing approach. An adjustment value for the output value of the function is calculated from a correction circuit generated according to one or more embodiments described herein. In one or more embodiments, the calculating of the approximate output value and the calculating of the adjustment value are performed in parallel. The adjustment value calculated by the correction circuit is then applied to the approximate output value to produce an adjusted output value for the function.

Various embodiments described herein are directed to providing a circuit for improving outliers and allowing other errors to get worse without exceeding a desired tolerance by exploiting patterns in the approximation results to reduce circuit size. One or more embodiments described herein are extensible to be applicable to any function that is only slightly out of tolerance in certain intervals. In accordance with one or more embodiments, for cases with few values which are not correctly rounded, heuristics are used to generate a CNF/DNF expression which is converted into an outlier correction circuit.

Two different primary methods are described for correcting function approximation outliers in accordance with one or more embodiments. A first primary method is referred to as the greedy method in which input data is separated into two different sets. Set A contains input data that requires correction, and Set B contains data that would become incorrect if the correction is applied. Then, every disjunctive clause with a set number of terms that make all members in Set B, False is chosen. From this set of disjunctive clauses, a subset of clauses is constructed by iteratively selecting a clause on which at least one new member of Set A evaluates to True. This procedure is repeated until a collection of disjunctive clauses are obtained that covers the entirety of Set A.

The second primary method is referred to as the bit minimization method. In the bit minimization method, all subsets of an input bit pattern that do not have overlapping values are found, and from that subset, one of the bit patterns is selected to mask all of set A. The selected mask is used to generate a CNF/DNF expression which may be simplified further using a satisfiability (SAT) solver in some embodiments. The CNF/DNF expression is then converted into a correction circuit composed of logic gates (e.g., OR gates and AND gates). Each of these primary methods are described in further detail below.

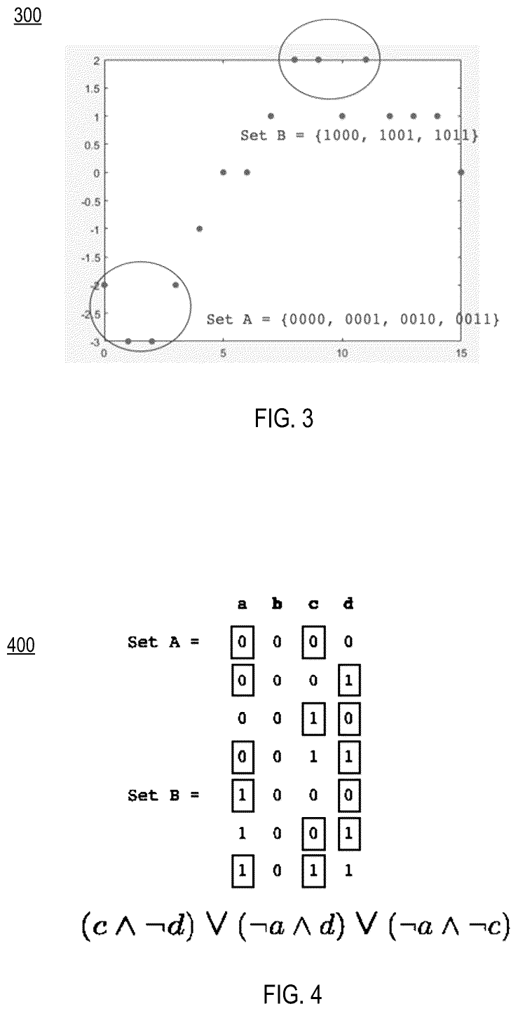

FIG. 3 shows an example plot 300 of identifying CNF circuits according to embodiments of the present disclosure. FIG. 3 shows a simplified subinterval that is similar to FIG. 2, having a goal of correcting the −3 ulp error outliers. Sets A and Set B are defined to filter inputs of interest into two parts. Set A contains inputs with the two most negative ulp errors, and Set B contains inputs with the most positive ulp errors. The specification that should be satisfied from a function is that it should return +1 for inputs belonging to Set A, and −1 for inputs belonging to Set B. A representation for the inputs are further defined. For each input of the subinterval, the input's binary representation can be written. In the example of FIG. 3, the precision is n=4, so each input can be written as 0000, 0001, . . . , up to 1111.

Referring again to FIG. 3, it can be seen that Set A and Set B are as follows:
A={0000, 0001, 0010, 0011}
B={0111, . . . , 1110}

These two sets specify the correction to be applied to the inputs in order to correct the outliers of −3 ulps. Inputs not included in either sets are treated as “don't cares”; the function satisfying the specification is free to add or subtract 1 ulp from their outputs. This is important, as not only the function is less restricted in its implementation, but the worst ulp error bounds on the overall function are maintained.

In the example, the two most positive/negative ulp errors are specified instead of only one because if the next most positive/negative ulp error are not controlled, they end up as “don't cares”. If an implementation, for example, subtracts one ulp from the next most negative output, we end up with the same overall ulp error bounds on the function. By the same reasoning, we do not include the next most positive ulp error for this particular case as we do not need to shrink the upper bound ulp error down to 1 ulp.

The greedy method attempts to minimize the number of clauses in the final DNF expression by grouping terms from both sets that share common bits. For a clause to cover terms in both sets, the clause in one set should be the negation in the other set. This ensures that true and false are returned respectively for Set A and Set B.

An embodiment of a heuristic process to generate a DNF circuit according to the greedy method is as follows:
(1) Identify conjunctive clauses (which corresponds to AND gates) with a set number of terms that make all members in Set B false.
(2) For each conjunctive clause, collect members from Set A that evaluates to true.
(3) Repeat step 2 until the entirety of Set A is set to true.
(4) Disjunct the negated conjunctive clauses (OR the AND results).

Conjunctive clauses selected in Step 1 should be performed such that each clause attempts to cover the maximal number of negated terms from Set A. The number of literals in each clause is also subject to the number of terms that can be covered in Set A. A clause with more literals can cover more negated terms in Set A, but the tradeoff is that each clause will have additional literals that will increase the circuit area size.

FIG. 4 shows a table 400 of clauses generated from the greedy method according to embodiments of the present disclosure. Using the example from FIG. 3 to demonstrate the greedy method, FIG. 4 shows a table of clauses with two literals that was generated from the greedy algorithm which was used to correct an approximation to reciprocal single-precision for the interval [1, 2). Each member in Set B is assigned unique clauses, each with two literals: Clause 1 of Set B includes c=0 and d=1 in the second row of Set B; Clause 2 includes a=1 and d=0 in the first row of Set B; and Clause 3 includes a=1 and c=1 in the third row of Set B.

Next, the corresponding literals in Set A that are negated in Step 2 are found: c=1 and d=0 in the third row of Set A having its literals negated by Clause 1 of Set B; Clause 2 has been selected to cover two terms in Set A including a=0 and d=1 in row 2 of Set A, and a=0 and d=1 in row 4 of Set A; the literals in Set A that are negated by Claim 3 of Set B include a=0 and c=0 in the first row of Set A. The final disjuncted expression is then produced as shown in FIG. 4 as (c ∧ ¬d) ∨ (¬a ∧ d) ∧ (¬a ∧ ¬c), where “∧” represents an AND operation, “¬” indicates negation, and “∧” represents an “OR” operation. Accordingly, a correction circuit can be readily constructed according to the final disjunct expression.

In practice, Step 1 may be performed in tandem with Step 2 to ensure that as many terms in Set A as possible are covered. Without having Clause 2 cover two terms in Set A, an additional clause that covers the fourth member in Set A would be needed. Note that the column a is sufficient to distinguish between the values in Set A and Set B (i.e., it is false for Set A and true for Set B). Indeed, this is the case for this example, but a two-literal clause is demonstrated to show how the greedy method would perform for more complicated cases. In various embodiments, the algorithm greedily identifies the largest number of terms that can be covered in each iteration for a preset number of literals desired for each clause.

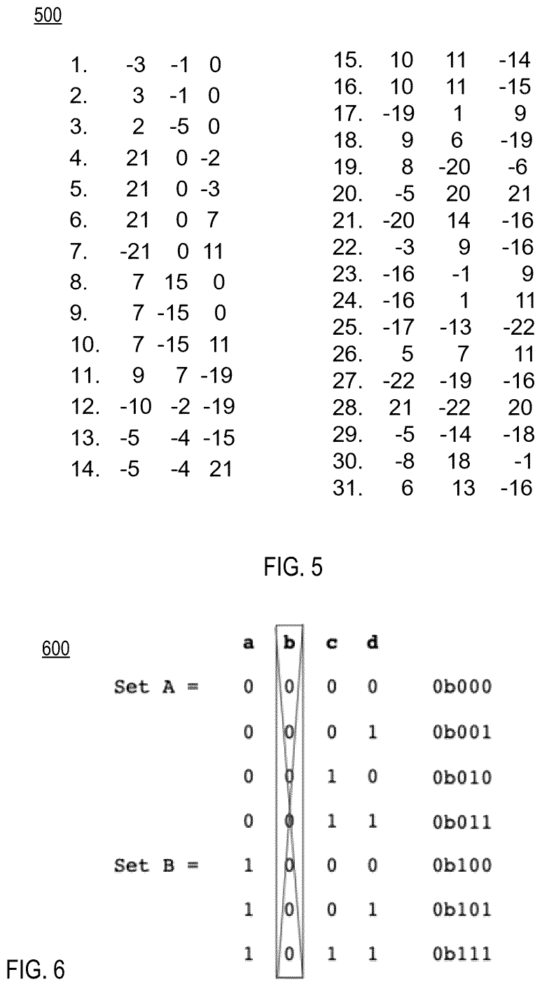

FIG. 5 shows an example correction circuit description 500 in table form for a single precision reciprocal according to embodiments of the present disclosure. The correction circuit description 500 covers the entire mantissa range of single precision. Each line is a conjunctive clause that includes 3 bits OR'd together. The number indicates bit position, and negative indicates negation of a bit. In the example of FIG. 5, the correction circuit includes 31 OR3 gates and 31-input AND reduction.

Referring now to the bit minimization method for correcting function approximation outliers, instead of finding maximal covers to each set, the task is deferred to a SAT minimizer that takes a CNF/DNF specification and attempts to simplify the expression. The bit minimization method generates the initial normal form expression. Methods and tools already exist that can take such a specification and perform simplifications, especially in the area of SAT solving.

In an embodiment, a heuristic for the bit minimization method is as follows:
(1) Identify bits that are set to the same value in each clause and mask those bits away.
(2) Consider the tree of subsets of the remaining columns.
Perform a depth-first search to find a maximal set of columns which can be eliminated while still separating sets A and B using the remaining clauses.
(3) Now remove duplicate conjunctions in the disjunction set for Set A or Set B. Note that clauses in A cannot occur in B and vice versa, even though they can be duplicated within one of A or B by column elimination.

The goal of this method is to generate unique Boolean clauses for each member in Set A and Set B. Unlike the greedy method previously described, no attempt is made to relate terms in Set A and Set B, we only need to be able to identify each input uniquely. While it cannot be guaranteed that simplification will lead to a minimal expression, it is relatively easy to generate these Boolean clauses and a SAT simplifier is chosen to simplify the expression. In essence, all bits in the inputs that are set to the same value are masked, and the masked inputs are used as clauses in the DNF expression.

FIG. 6 shows generating Boolean bits 600 to be fed into a SAT minimizer according to embodiments of the present disclosure. FIG. 5 shows the greedy method applied to the example of FIG. 3. Set A corresponds to the terms that are desired to in the final expression to return false, while Set B is desired to return true. Column b is discarded as it is redundant. From there, at least 3 bits are required to represent 7 input values. Thus, each clause in the final CNF will have three literals. Next, the sets are fed into the SAT minimizer to generate the final expression for the correction circuit.

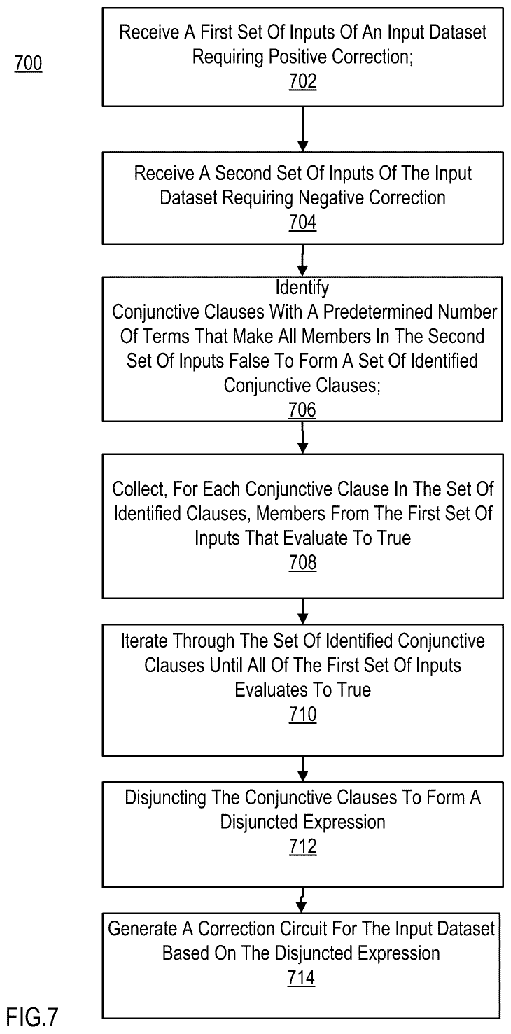

FIG. 7 is a flowchart of an example method 700 for correcting function approximation outliers according to some embodiments of the present disclosure. The method 700 includes receiving 702 a first set of inputs of an input dataset requiring positive correction; and receiving 704 a second set of inputs of the input dataset requiring negative correction. In an embodiment, the input dataset is associated with an approximation function. In an embodiment, the first set of inputs includes the two most negative unit in last place errors of the input dataset. In an embodiment, the second set of inputs includes a two most positive unit in last place errors of the input dataset.

The method further includes identifying 706 conjunctive clauses with a predetermined number of terms that make all members in the second set of inputs false to form a set of identified conjunctive clauses. The method 700 further includes collecting 708, for each conjunctive clause in the set of identified clauses, members from the first set of inputs that evaluate to true. In an embodiment, the conjunctive clauses are associated with AND gates of the correction circuit.

The method 700 further includes iterating 710 through the set of identified conjunctive clauses until all of the first set of inputs evaluates to true. The method 700 further includes disjuncting 712 the conjunctive clauses to form a disjuncted expression. In an embodiment, disjuncting the conjunctive clauses includes performing OR operations on all AND results. In an embodiment, the conjunctive clauses are associated with AND gates of the correction circuit. In an embodiment, the disjuncted expression comprises a disjunctive normal form (DNF) expression. The method further includes generating 714 a correction circuit for the input dataset based on the disjuncted expression.

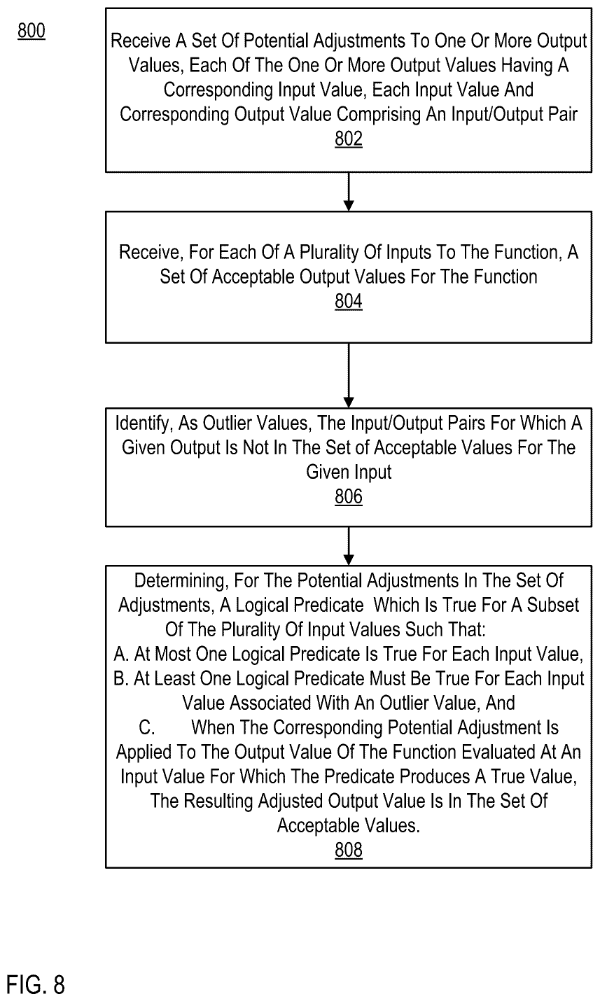

FIG. 8 is a flowchart of another example method 800 for correction of outliers for a function according to some embodiments of the present disclosure. The method 800 includes receiving 802 a set of potential adjustments to one or more output values of a function. Each of the one or more output values has a corresponding input value, and each input value and corresponding output value comprise an input/output pair. The method 800 further includes receiving 804, for each of a plurality of inputs to the function, a set of acceptable output values for the function.

The method 800 further includes identifying 806, as outlier values, the input/output pairs for which a given output is not in the set of acceptable values for the given input. The method 800 further includes determining 808, for the potential adjustments in the set of adjustments, a logical predicate which is true for a subset of the plurality of input values such that:
a. at most one logical predicate is true for each input value,
b. at least one logical predicate must be true for each input value associated with an outlier value, and
c. when the corresponding potential adjustment is applied to the output value of the function evaluated at an input value for which the predicate produces a true value, the resulting adjusted output value is in the set of acceptable values.

In various embodiments, a logical predicate is a logical function containing variables, that may be true or false depending on the variable values. In an embodiment, the method 800 further includes determining a hardware circuit to realize the logical predicate. In another embodiment, the method further includes determining one or more software functions to realize the logical predicate.

In an embodiment, the input values and the output values are one or more of sets of binary representations from a set of integer values, floating-point values, vectors of integer values, or vectors of floating-point values. In an embodiment, the function is an approximation of a mathematical function, and the set of acceptable values are determined based upon one of a maximum tolerated absolute approximation error, a maximum tolerated positive approximation error, or a maximum tolerated negative approximation error.

In an embodiment, the logical predicate comprises a disjunction of a conjunction. In an embodiment, the logical predicate is determined based on a greedy algorithm or a bit minimization algorithm as further described herein. In various embodiments, the potential adjustments include correction for positive outliers, correction for negative outliers, correction for both positive or negative outliers, correction for single unit in last place outliers or multiple unit in last place outliers.

In view of the explanations set forth above, readers will recognize that the benefits of correcting function approximation outliers according to embodiments of the present disclosure include:
Allowing small circuits to be inserted into an existing floating-point pipeline without changing the timing (e.g., number of cycles) or adding fewer additional cycles than existing methods.
Can be generalized to improve only the upper bound, the lower bound, or both.
Can be tuned to eliminate a Newton-Rhapson iteration.
Achieves required accuracy with reduced table size which is useful for providing sufficient accuracy for applications.

Exemplary embodiments of the present disclosure are described largely in the context of a fully functional computer system for correcting function approximation outliers. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method for correction of outliers for a function, the method comprising:
receiving a set of potential adjustments to one or more output values of a function, each of the one or more output values having a corresponding input value, each input value and corresponding output value comprising an input/output pair;
receiving, for each of a plurality of inputs to the function, a set of acceptable output values for the function;
identifying, as outlier values, the input/output pairs for which a given output is not in the set of acceptable values for the given input;
determining, for the potential adjustments in the set of adjustments, a logical predicate which is true for a subset of the plurality of input values such that:
a. at most one logical predicate is true for each input value,
b. at least one logical predicate must be true for each input value associated with an outlier value, and
c. when the corresponding potential adjustment is applied to the output value of the function evaluated at an input value for which the predicate produces a true value, the resulting adjusted output value is in the set of acceptable values.

2. The method of claim 1, further comprising determining a hardware circuit to realize the logical predicate.

3. The method of claim 1, further comprising determining one or more software functions to realize the logical predicate.

4. The method of claim 1, wherein the input values and the output values are one or more of sets of binary representations from a set of integer values, floating-point values, vectors of integer values, or vectors of floating-point values.

5. The method of claim 1, wherein the function is an approximation of a mathematical function, and the set of acceptable values are determined based upon one of a maximum tolerated absolute approximation error, a maximum tolerated positive approximation error, or a maximum tolerated negative approximation error.

6. The method of claim 1, wherein the logical predicate comprises a disjunction of a conjunction.

7. The method of claim 1, wherein the logical predicate is determined based on a greedy algorithm.

8. The method of claim 1, wherein the logical predicate is determined based on a bit minimization algorithm.

9. The method of claim 1, wherein the potential adjustments include correction for positive outliers, correction for negative outliers, correction for both positive or negative outliers, correction for single unit in last place outliers or multiple unit in last place outliers.

10. A method for correction of outliers in a dataset, the method comprising:
receiving a first set of inputs of an input dataset requiring positive correction;
receiving a second set of inputs of the input dataset requiring negative correction;
identifying conjunctive clauses with a predetermined number of terms that make all members in the second set of inputs false to form a set of identified conjunctive clauses;
collecting, for each conjunctive clause in the set of identified clauses, members from the first set of inputs that evaluate to true;
iterating through the set of identified conjunctive clauses until all of the first set of inputs evaluates to true;
disjuncting the conjunctive clauses to form a disjuncted expression; and
generating a correction circuit for the input dataset based on the disjuncted expression.

11. The method of claim 10, wherein the input dataset is associated with an approximation function.

12. The method of claim 10, wherein disjuncting the conjunctive clauses includes performing OR operations on all AND results.

13. The method of claim 10, wherein the first set of inputs includes a two most negative unit in last place errors of the input dataset.

14. The method of claim 10, wherein the second set of inputs includes a two most positive unit in last place errors of the input dataset.

15. The method of claim 10, wherein the disjuncted expression comprises a disjunctive normal form (DNF) expression.

16. The method of claim 10, wherein the conjunctive clauses are associated with AND gates of the correction circuit.

17. An apparatus for correction of outliers in a dataset, the apparatus comprising:
a processor; a computer memory operatively coupled to the processor; and
logic configured to cause the apparatus to:
receive a first set of inputs of an input dataset requiring positive correction;
receive a second set of inputs of the input dataset requiring negative correction;
identify conjunctive clauses with a predetermined number of terms that make all members in the second set of inputs false to form a set of identified conjunctive clauses;
collect, for each conjunctive clause in the set of identified clauses, members from the first set of inputs that evaluate to true;
iterate through the set of identified conjunctive clauses until all of the first set of inputs evaluates to true;
disjunct the conjunctive clauses to form a disjuncted expression; and
generate a correction circuit for the input dataset based on the disjuncted expression.

18. The apparatus of claim 17, wherein the input dataset is associated with an approximation function.

19. The apparatus of claim 17, wherein disjuncting the conjunctive clauses includes performing OR operations on all AND results.

20. The apparatus of claim 17, wherein the first set of inputs includes a two most negative unit in last place errors of the input dataset.
